(19) United States
(12) Patent Application Publication
(10) Pub. No.: US 2019/0179549 A1
(43) Pub. Date: Jun. 13, 2019

(54) STOCHASTIC DATA-DRIVEN DYNAMIC LOGIC REALLOCATION AND LOGIC CACHE METHOD FOR RUN-TIME ADAPTIVE COMPUTING ARCHITECTURE

(71) Applicant: THE CHARLES STARK DRAPER LABORATORY, INC., Cambridge, MA (US)

(72) Inventor: Antonio de la Serna, Natick, MA (US)

(21) Appl. No.: 16/213,235

(22) Filed: Dec. 7, 2018

Related U.S. Application Data
(60) Provisional application No. 62/595,949, filed on Dec. 7, 2017.
(60) Provisional application No. 62/595,953, filed on Dec. 7, 2017.
(60) Provisional application No. 62/595,964, filed on Dec. 7, 2017.

(51) Int. Cl. G06F 3/06

(52) U.S. Cl. CPC G06F 3/0631; G06F 3/0673; G06F 3/064; G06F 3/0604

(57) ABSTRACT

According to one embodiment, a method is provided for reallocating logic blocks in reconfigurable hardware. The method includes acts of receiving a first bit array having a plurality of bits, the plurality of bits including a first subset of bits and a second subset of bits, providing the first subset of bits to a first logic block of a plurality of logic blocks, and the second subset of bits to a second logic block of the plurality of logic blocks, determining that the first logic block has not performed a calculation for a specified amount of time, and reconfiguring the first logic block to process at least a portion of a second bit array.

### CROSS-REFERENCE TO RELATED APPLICATIONS

This application claims priority to U.S. Provisional Application Ser. No. 62/595,949, titled “STOCHASTIC DATA-DRIVEN DYNAMIC LOGIC REALLOCATION,” filed on Dec. 7, 2017, and to U.S. Provisional Application Ser. No. 62/595,953, titled “CROSS-ASSEMBLER FOR CANONICAL BOOLEAN MINIMIZATION OF A PROCESSOR INSTRUCTION STREAM,” filed on Dec. 7, 2017, and to U.S. Provisional Application Ser. No. 62/595,964, titled “LOGIC CACHE METHOD FOR RUN-TIME ADAPTIVE COMPUTING ARCHITECTURE,” filed on Dec. 7, 2017, each of which is incorporated herein by reference in its entirety.

### FIELD OF TECHNOLOGY

The disclosure relates to dynamic data-driven reallocation of logic in configurable computing hardware and a logic cache method for a run-time adaptive computing architecture.

### SUMMARY

According to one embodiment, a method is provided for reallocating logic blocks in reconfigurable hardware. The method includes acts of receiving a first bit array having a plurality of bits, the plurality of bits including a first subset of bits and a second subset of bits, providing the first subset of bits to a first logic block of a plurality of logic blocks, and the second subset of bits to a second logic block of the plurality of logic blocks, determining that the first logic block has not performed a calculation for a specified amount of time, and reconfiguring the first logic block to process at least a portion of a second bit array.

In one embodiment, the method includes processing, by the first logic blocks, the first subset of bits to produce an output, and holding the output for reuse. In some embodiments, the method includes providing a first timestamp to the first logic blocks simultaneously with the first subset of bits. In one embodiment, the method includes determining, by the first logic block, that the first subset of bits is different than a most-recently received subset of bits, and storing, by the first logic block, the first timestamp.

In some embodiments, the method includes determining, by the first logic block, that the first subset of bits is the same as a most-recently received subset of bits, and disregarding, by the first logic block, the first timestamp. In one embodiment, the method includes polling the plurality of logic blocks for a stored timestamp, and receiving a plurality of timestamps from the plurality of logic blocks, the plurality of timestamps including the first timestamp. In at least one embodiment, the method includes determining whether any timestamp of the plurality of timestamps has exceeded a threshold amount of time.

In some embodiments, the method includes determining that the first logic block satisfies a condition. In some embodiments, determining that the first logic block has not performed the calculation for the specified amount of time includes measuring an energy consumption by a transistor in the first logic block. In at least some embodiment, determining that the first logic block has not performed the calculation for the specified amount of time includes determining that a minimum number of clock cycles have elapsed. In one embodiment, determining that the first logic block has not performed the calculation for the specified amount of time includes determining that a minimum number of fractions of a second have elapsed.

According to one embodiment, a reconfigurable Integrated Circuit (IC) is provided including one or more input pins configured to receive a first bit array having a plurality of bits, the plurality of bits including a first subset of bits and a second subset of bits, a plurality of logic blocks including a first logic block, a second logic block, and a third logic block, the first logic block and the second logic block being interconnected, and a controller coupled to the one or more input pins and the plurality of logic blocks, the controller configured to provide the first subset of bits to the first logic block of the plurality of logic blocks, and the second subset of bits to the second logic block of the plurality of logic blocks, determine that the first logic block has not performed a calculation for a specified amount of time, disconnect the first logic block from the second logic block, and connect the first logic block to the third logic block.

In some embodiments, the IC includes a memory, wherein the first logic block is configured to process the first subset of bits to produce an output, and wherein the controller is further configured to store the output in the memory. In some embodiments, determining that the first logic block has not performed the calculation for the specified amount of time includes measuring an energy consumption by a transistor in the first logic block. In one embodiment, the controller is further configured to provide a first timestamp to the first logic block simultaneously with the first subset of bits.

In at least one embodiment, the first logic block includes a memory and is configured to determine that the first subset of bits is different than a most-recently received subset of bits, and store the first timestamp. In some embodiments, the first logic block is further configured to determine that the first subset of bits is the same as a most-recently received subset of bits, and disregard the first timestamp. In one embodiment, the controller is further configured to poll the plurality of logic blocks for a stored timestamp, and receive a plurality of timestamps from the plurality of logic blocks, the plurality of timestamps including the first timestamp.

In one embodiment, the controller is further configured to determine, based on the plurality of timestamps, that the first timestamp has exceeded a threshold amount of time. In some embodiments, determining that the first logic block has not performed the calculation for the specified amount of time includes determining that a minimum number of clock cycles have elapsed. In at least one embodiment, determining that the first logic block has not performed the calculation for the specified amount of time includes determining that a minimum number of fractions of a second have elapsed.

Aspects and embodiments disclosed herein relate to a method of partitioning logic blocks in reconfigurable hardware including a plurality of logic block partitions, the method comprising acts of collecting information indicative of a previous calculation from each logic block partition of the plurality of logic block partitions, identifying, based on the information, a first logic block partition configured to execute a first calculation that is least likely to be reused, and reconfiguring the first logic block partition to execute a second calculation based on the identification.

In one embodiment, the information includes timestamp information. In some embodiments, the timestamp information includes a plurality of timestamps corresponding to a respective logic block partition of the plurality of logic block partitions and indicative of a time at which a corresponding logic block partition last executed a calculation. In at least one embodiment, the plurality of timestamps includes a first timestamp corresponding to the first logic block partition, and wherein the first timestamp is an earliest timestamp of the plurality of timestamps.

In at least one embodiment, the method includes predicting a likelihood of a second logic block partition being required, wherein the plurality of logic block partitions does not include the second logic block partition. In one embodiment, the method includes pre-fetching, based on the prediction, the second logic block partition. In some embodiments, pre-fetching the second logic block partition includes reconfiguring the first logic block partition to the second logic block partition.

According to one embodiment, a reconfigurable Integrated Circuit (IC) is provided including a plurality of logic block partitions including a first logic block partition and a second logic block partition, and a controller coupled to the plurality of logic block partitions, the controller configured to collect information from the first logic block partition and the second logic block partition, determine, based on the information, that the first logic block partition is less likely to be reused than the second logic block partition, and reconfigure the first logic block partition to a third logic block partition.

In one embodiment, the information includes timestamp information. In some embodiments, the timestamp information includes a plurality of timestamps corresponding to a respective logic block partition of the plurality of logic block partitions and indicative of a time at which a corresponding logic block partition last executed a calculation. In some embodiments, the plurality of timestamps includes a first timestamp corresponding to the first logic block partition, and wherein the first timestamp is an earliest timestamp of the plurality of timestamps. In at least one embodiment, the controller is further configured to predict a likelihood of a third logic block partition being required. In some embodiments, the plurality of logic block partitions does not include the third logic block partition. In an embodiment, the controller is further configured pre-fetch, based on the prediction, the third logic block partition. In some embodiments, the controller pre-fetching the third logic block partition includes the controller reconfiguring the first logic block partition to the third logic block partition.

Aspects and embodiments disclosed herein relate to a method of partitioning logic blocks in reconfigurable hardware including a plurality of logic block partitions, the method comprising acts of collecting information indicative of a previous calculation from each logic block partition of the plurality of logic block partitions, identifying, based on the information, a first logic block partition configured to execute a first calculation that is least likely to be reused, and reconfiguring the first logic block partition to execute a second calculation based on the identification.

In one embodiment, the information includes timestamp information. In some embodiments, the timestamp information includes a plurality of timestamps corresponding to a respective logic block partition of the plurality of logic block partitions and indicative of a time at which a corresponding logic block partition last executed a calculation. In at least one embodiment, the plurality of timestamps includes a first timestamp corresponding to the first logic block partition, and wherein the first timestamp is an earliest timestamp of the plurality of timestamps.

In at least one embodiment, the method includes predicting a likelihood of a second logic block partition being required, wherein the plurality of logic block partitions does not include the second logic block partition. In one embodiment, the method includes pre-fetching, based on the prediction, the second logic block partition. In some embodiments, pre-fetching the second logic block partition includes reconfiguring the first logic block partition to the second logic block partition.

According to one embodiment, a reconfigurable Integrated Circuit (IC) is provided including a plurality of logic block partitions including a first logic block partition and a second logic block partition, and a controller coupled to the plurality of logic block partitions, the controller configured to collect information from the first logic block partition and the second logic block partition, determine, based on the information, that the first logic block partition is less likely to be reused than the second logic block partition, and reconfigure the first logic block partition to a third logic block partition.

In one embodiment, the information includes timestamp information. In some embodiments, the timestamp information includes a plurality of timestamps corresponding to a respective logic block partition of the plurality of logic block partitions and indicative of a time at which a corresponding logic block partition last executed a calculation. In some embodiments, the plurality of timestamps includes a first timestamp corresponding to the first logic block partition, and wherein the first timestamp is an earliest timestamp of the plurality of timestamps.

In at least one embodiment, the controller is further configured to predict a likelihood of a third logic block partition being required. In some embodiments, the plurality of logic block partitions does not include the third logic block partition. In an embodiment, the controller is further configured pre-fetch, based on the prediction, the third logic block partition. In some embodiments, the controller pre-fetching the third logic block partition includes the controller reconfiguring the first logic block partition to the third logic block partition.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 illustrates a block diagram of a portion of a reconfigurable Integrated circuit (IC);

FIG. 2 illustrates a process of reconfiguring IC logic blocks;

FIG. 3 illustrates a block diagram of a reconfigurable IC;

FIG. 4 illustrates a process of reconfiguring logic block partitions in the reconfigurable IC; and

FIG. 5 illustrates a process of minimizing a stream of processor instructions.

### DETAILED DESCRIPTION

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are no intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. In addition, in the event of inconsistent usages of terms between this document and documents incorporated herein by reference, the term usage in the incorporated features is supplementary to that of this document; for irreconcilable differences, the term usage in this document controls.

Conventional Integrated Circuits (ICs) may be implemented using fixed logical blocks, or reconfigurable logical blocks. Generally speaking, an IC implemented using fixed logical blocks includes hardware having pre-defined, non-reconfigurable physical connections between specific logical blocks, such as logic gates. One example of an IC implemented using fixed logic is an Application-Specific Integrated Circuit (ASIC).

In contrast, an IC implemented using reconfigurable logical blocks includes hardware having reconfigurable physical connections between logical blocks. One example of an IC implemented using reconfigurable logical blocks is a Field-Programmable Gate Array (FPGA).

FPGAs include logical blocks that may be reconfigured after manufacture, effectively allowing the FPGA to be programmed in the field (i.e., after manufacture) by designers or developers. FPGAs may have particular advantages over fixed logic ICs because, among other advantages, instructions executed on an FPGA may be executed in true parallel. More specifically, because the logical blocks may be reconfigured to hardwire groups of desired circuits, each circuit may execute simultaneously without sharing any resources with the other circuits.

An FPGA generally consists of several logic blocks, and several interconnects connecting subsets of the logic blocks together. Each subset of logic blocks represents a separate circuit isolated from the remainder of the logic blocks. Conceptually, an FPGA may be thought of as a collection of discrete circuits, where each circuit is implemented by an interconnected subset of logic blocks.

Whereas a fixed-logic ASIC may include logical blocks that are interconnected with static physical connections, the interconnects connecting a subset of logic blocks in an FPGA are capable of being reset, or “flushed,” to a default state and reconfigured by a user to connect a different subset of logic blocks together. The user may flush and reconfigure the FPGA in the field as many times as is desired. Accordingly, when a user no longer needs a subset of logic blocks that were configured as a desired circuit, the logic blocks may be reallocated to perform a new function.

Logic blocks represent the fundamental logical building blocks of the FPGA. A typical 4-input logic block may include, for example, a 4-input Look-Up Table (LUT), a full adder, and a D-type flip-flop. The LUT is configured to perform any Boolean operations. The full adder is configured to perform binary addition. The flip-flop is a sequential logic element configured to provide stable storage of information.

Each logic block is therefore capable of executing fundamental logic operations (including Boolean calculations, addition, and data storage) tasked to the FPGA. When multiple logic blocks are connected together via one or more interconnects to form a set of logic blocks, the set of logic blocks is capable of executing complex logical operations as a single cohesive unit.

For example, consider a first set of interconnected logic blocks tasked with executing a first computation. Each logic block of the first set of interconnected logic blocks is tasked with a calculation as a subset of the first computation. When the first set of the logic blocks completes the execution of the first computation, the first set of the logic blocks may no longer be needed if the FPGA does not need to perform the first computation again.

If the first set of logic blocks is no longer needed, then the first set of the logic blocks may be flushed to reset to a default state. The first set of logic blocks may then be reconfigured to execute a second computation from a queue of computations that the FPGA is to execute. Moreover, while the first set of logic blocks is executing the first computation or the second computation, a second set of logic blocks may be executing a third computation simultaneously without any reliance on the operation of the first set of logic blocks. FPGAs therefore provide a dynamically reconfigurable solution to executing computations in parallel, unlike fixed logic ICs.

Similar principles apply to other reconfigurable ICs, and FPGAs have been specifically identified for purposes of explanation only. For example, similar principles apply with respect to Programmable Logic Devices (PLDs) and other reconfigurable ICs described below.

In an ideal implementation, every logic block of a reconfigurable IC (for example, a logic block of an FPGA) is performing a useful calculation at any given time. If the IC has more processing power than is necessary for a computational workload, then the IC may be considered to be over-engineered to a task in terms of a device physical footprint and a device energy consumption.

However, even if every logic block of the IC is tasked with operating on an input value at any given time, the IC may not be operating at a maximum efficiency. For example, consider a logic block that is tasked with operating on a 4-bit input to produce an output. The first time the logic block receives the 4-bit input, the logic block performs a necessary calculation on the input to produce the output.

If the logic block continues to receive the same input value, however, the logic block does not need to continuously recalculate a result, because the result of the calculation will not change if the input does not change. Accordingly, the result of the calculation may be stored for reuse such that the same result need not be repeatedly computed. Dedicating a logic block to simply storing previously computed data is wasteful in terms of processing time and energy consumption, because the logic block could provide more value by being used to perform calculations on queued input data streams. It would be advantageous to be able to identify a logic block that is unlikely to perform a new calculation on an input data stream such that the logic block may be reconfigured to perform a more useful operation.

It is therefore to be appreciated that, if an input data stream which is unlikely to change can be identified, significant improvements in reconfigurable IC efficiency may be achieved. More specifically, if such a data stream is identified, then one or more logic blocks tasked with processing the data stream may be reconfigured to perform other operations (for example, processing another data stream). The output value produced from the static data stream is stored and reused by the IC as it becomes necessary. If the input data stream does subsequently change, then logic may be reallocated to its original purpose to perform a new calculation on the input data stream.

Accordingly, systems and methods are provided that yield a significant increase in system performance for reconfigurable hardware by implementing stochastic data analysis. Input data is analyzed to determine if one or more portions of the data meet specified criteria indicating that the portions of the data are likely to remain fixed. Responsive to identifying one or more portions of the data that are unlikely to change in the relative short term, logic blocks configured to operate on those portions of the data are reconfigured to perform computations on other data that is awaiting logical resources.

By reconfiguring logic resources that do not meet a minimum level of activity, logic block efficiency may be increased. Increasing logic block efficiency increases the volume of computation that may be performed by a reconfigurable IC having a fixed number of logic blocks, thereby increasing the processing power of a reconfigurable IC without adding any additional components to the IC.

Reconfigurable and fixed logic ICs are similar in following the same convention of designing arithmetic data widths, operations, and control paths for all valid data scenarios. For example, a specific reconfigurable IC may be designed to receive words having a fixed word width, such as a 16-bit word width. A word is an example of a data structure that stores bits (for example, a bit array). Each word may be provided to several logic blocks where, for example, the word width exceeds the number of inputs per logic block.

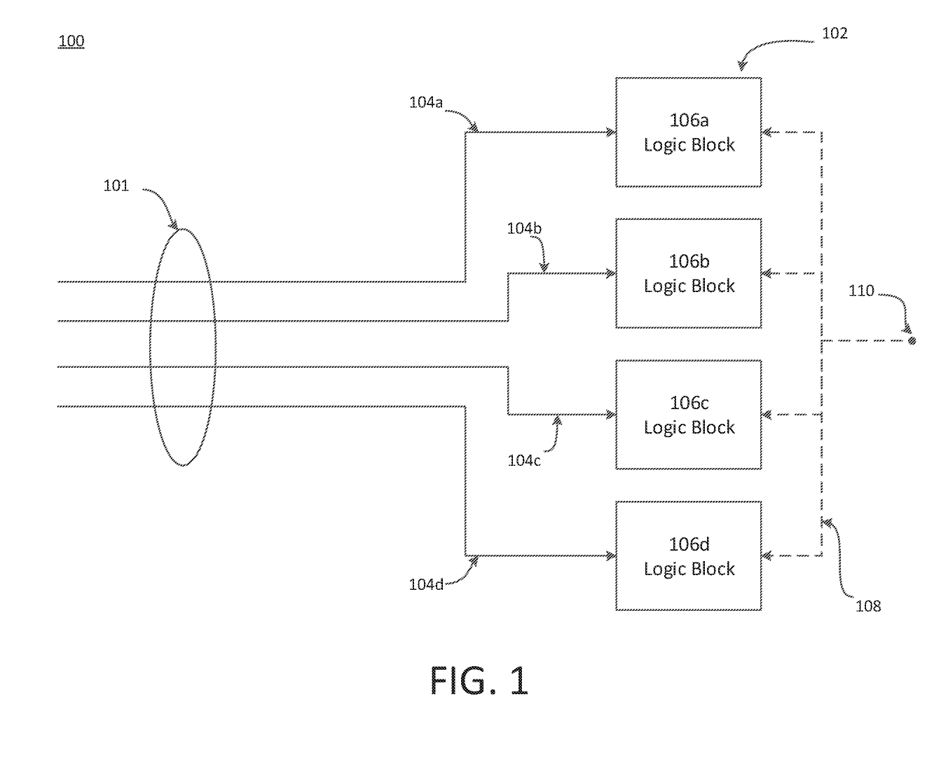

FIG. 1 illustrates a block diagram of a portion of an exemplary reconfigurable IC 100. The portion of the IC 100 includes an input word 101 and a first set of logic blocks 102 that has been configured by generating interconnects 108 to connect the first set of logic blocks 102 together. The input word 101 is a 16-bit word having a first byte 104a, a second byte 104b, a third byte 104c, and a fourth byte 104d. The first set of logic blocks 102 includes a first logic block 106a, a second logic block 106b, a third logic block 106c, and a fourth logic block 106d, each of which is configured to receive a 4-bit input.

In an example operation, the word 101 is received by the portion of the IC 100 via one or more Input/Output (I/O) pins. The IC routes the word 101 to the first set of logic blocks 102, which is interconnected by the interconnects 108. The first set of logic blocks 102 is configured to perform a calculation on the word 101 and provide a result of the calculation as an output 110.

One or more bytes of the word 101 may remain static over time. For example, suppose that the first byte 104a is a least significant byte, and the fourth byte 104d is a most significant byte. The fourth byte 104d may remain at a fixed value while the first byte 104a, the second byte 104b, and the third byte 104c may be non-fixed and change over time. This may occur, for example, where the word 101 is capable of representing a 4-byte value, but the values actually being processed by the FPGA are relatively small, meaning they are capable of being represented by 1, 2, or 3 bytes.

Because the fourth byte 104d remains fixed over time in this example, the computation executed by the fourth logic block 106d on the fourth byte 104d will yield the same result. Accordingly, repeatedly executing the computation by the fourth logic block 106d is unnecessary if the output value is already known for an unchanging input value. The fourth logic block 106d is therefore not providing any value because the result of the computation is already known. This may lead to inefficiencies where, for example, all of the IC's logic resources are being used and the IC has a queue of calculations awaiting logic resources to compute the calculations.

It would be advantageous to reconfigure the fourth logic block 106d to execute one or more of the queued calculations. The previously computed output value of the fourth logic block 106d may be stored for future reuse (for example, stored in IC Random Access Memory [RAM]) (not shown), and the fourth logic block 106d may be flushed and reconfigured to perform a different computation. This reconfiguration of the fourth logic block 106d allows subsequent computations to be performed at a higher throughput (i.e., sooner) than if the fourth logic block 106d were not re-configured separate from the first logic block 106a, the second logic block 106b, and the third logic block 106c. If the functionality of the fourth logic block 106d is subsequently necessary (for example, because the fourth byte 104d changes), then another logic block may be reconfigured to perform the operation of the fourth logic block 106d.

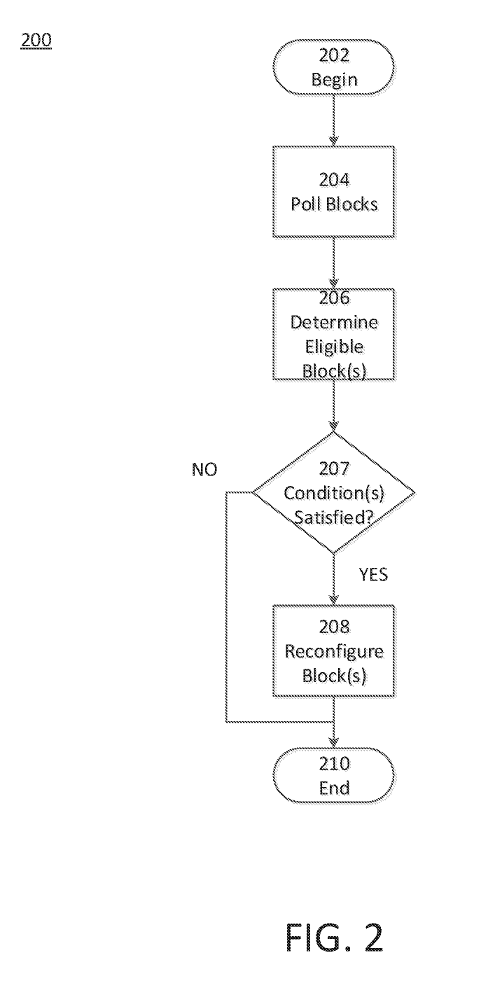

FIG. 2 illustrates a process 200 of reconfiguring logic blocks in a reconfigurable IC having several logic blocks. For example, the process 200 may be executed by a controller internal to the IC or external to the IC. At act 202, the process 200 begins. At act 204, each logic block of the several logic blocks is polled for timing information indicative of an amount of time that has elapsed since the logic block executed a calculation.

In a preferred embodiment, during operation, the IC may measure an energy consumption of one or more analog transistors within the logic block. A transistor-level analog measure of charge is detected, where the charge decays at a rate corresponding to a time constant. Accordingly, timing information may be derived from the energy measurement by extrapolating the energy to a decay time.

In another example, the IC may provide a synchronous clock signal and a data signal to each logic block of the several logic blocks. If an exemplary logic block of the several logic blocks determines that the received data signal is different than a previous data signal (for example, a most-recently received data signal), then the logic block executes a calculation on the data signal and records the time indicated by the synchronous clock signal.

Otherwise, if the logic block determines that the received data signal is the same as a previous data signal, then the logic block does not execute a calculation or record the time indicated by the synchronous clock signal. The logic block disregards the received timestamp, where disregarding may include not storing the timestamp in a memory. Accordingly, when the logic block is polled at act 204, the logic block will respond with a most-recently recorded clock signal indicative of a time that has elapsed since the logic block last executed a calculation.

At act 206, a determination is made as to which logic block or blocks may be eligible for reconfiguration. In some embodiments, multiple logic blocks may be considered eligible. For example, the eligible logic block or blocks can include a number of logic blocks that have received data which has not changed for a specified amount of time. A determination as to whether the eligible logic block has received a varying data input may be determined based on the energy consumption of one or more analog transistors within the eligible logic block, where a higher energy consumption is associated with execution of a calculation on a varying data input.

At act 207, a determination is made as to whether the eligible logic block(s) identified in act 206 satisfy one or more conditions. As discussed in greater detail below, the conditions may include one or more threshold conditions. For example, the threshold conditions may include temporal threshold conditions, data-dependent threshold conditions, or any other type of threshold conditions.

If the one or more threshold conditions are met for at least one of the eligible logic block or blocks (207 YES), then the eligible logic block or blocks is flagged for reconfiguration, and the process 200 continues to act 208. If none of the eligible logic block or blocks satisfies the one or more threshold conditions (207 NO), then none of the logic blocks are flagged and the process 200 ends at act 210.

At act 208, the block or blocks flagged for reconfiguration are reconfigured to handle a different calculation. For example, the reconfigured logic block or blocks may be reconfigured to handle one or more highest-priority computations awaiting the next available logic resources of the IC. The process 200 ends at act 210.

The determination of an eligible logic block as discussed above with respect to act 206 will now be described in greater detail. In some embodiments, a logic block is eligible for reconfiguration if a threshold amount of time has elapsed since a data input received by the logic block last changed. The threshold amount of time may be a fixed threshold expressed as a minimum number of clock cycles, a minimum number of seconds or fractions of a second, or another expression of time.

Alternatively, a threshold amount of time may be defined relative to other logic blocks of a group of logic blocks. For example, the threshold amount of time may be defined as a multiple of an average elapsed time since the group of logic blocks most recently executed a calculation. The threshold amount of time may be static or dynamic, and may be specified by a user or automatically determined by the IC.

The one or more threshold conditions discussed above with respect to act 207 will now be described in greater detail. In some embodiments, the one or more threshold conditions must be satisfied before an eligible logic block is reconfigured. Thresholds associated with the reconfiguration of the eligible logic block may be dependent on data type or expected data characteristics. For example, if the data is related to execution of a signal filter, threshold conditions for reconfiguration of an eligible logic block may be different than the threshold conditions for reconfiguration of an eligible logic block associated with data related to vibrations through water.

In some embodiments, threshold values may be set with respect to the number of logic blocks that may be reconfigured in any one instance. For example, logic blocks may not be reconfigured unless at least a fixed number of eligible logic blocks are reconfigured. Similarly, the number of logic blocks to be reconfigured at any one time may be limited, even if additional logic blocks are eligible for reconfiguration and otherwise satisfy one or more reconfiguration conditions.

The threshold number of logic blocks may be associated with a specific input word and defined by a threshold number of bits associated with the word. For example, for a 16-bit word, the logic blocks associated with the 16-bit word may not be reconfigured unless the eight most significant bits have not changed for a required minimum amount of time.

Alternate approaches may be implemented to identify a data stream which is unlikely to change. For example, trends or patterns in the data stream may be learned to determine whether the data stream is likely to change. Alternatively, temporal or spatial localities may be identified to predict future data stream values.

Although some of the foregoing examples describe the reconfiguration of an FPGA, the principles discussed above may be applied to alternate reconfigurable hardware. In some embodiments, the principles discussed above may be combined with additional improvements to reconfigurable hardware to provide synergistic increases in efficiency. For example, the principles discussed above may be implemented in combination with one or more additional principles, such as cross-bar fabric of Sum-of-Products (SOP) clusters, predictive cache-based pipelined dynamic partial reconfiguration, and Multi-Threshold NULLL Convention Logic (MTNCL) architecture.

A cross-bar fabric of SOP clusters generally describes an architecture organized into reconfigurable logic partitions, each partition being comprised of minimal SOP clusters interconnected by an array of cross-point switches. A predictive cache-based pipelined dynamic partial reconfiguration generally describes a prediction of which logic block partitions are least likely to be used in the future to identify an optimal partition to flush to avoid write-backs. A MTNCL architecture generally describes an architecture which eliminates requirements for input-completeness and observability which simplifies circuit design. Each of the foregoing principles is described in the Appendix of the present application, which is hereby incorporated by reference in its entirety.

Furthermore, although the foregoing examples have made reference to logic blocks configured to receive input data having a specified number of bits, the principles discussed herein are applicable to logic blocks capable of receiving input data having any number of bits, including 3-bit input data, 8-bit input data, and so forth.

Accordingly, embodiments disclosed above enable one or more logic blocks which have not been recently presented with a new input to be reconfigured to perform a different logical function. However, reconfiguration of logic blocks is not instantaneous. To reconfigure a set of logic blocks to form a new partition, a configuration bitstream specifying the configuration of the partition must be fetched from a memory. Fetching the partition configuration bitstream inherently has a latency that decreases computational efficiency, because the logic blocks are not performing any “useful” processing when they are being reconfigured.

Systems and methods are provided that reduce latency caused by reconfiguring logic blocks. More specifically, when reconfiguration of logic blocks is necessary, a subset of logic blocks that is unlikely to be needed again will be reconfigured. This may reduce an amount of “write-backs,” where a partition is flushed and subsequently reconfigured to the same partition before being flushed. Write-backs may be considered undesirable, because if a frequently needed partition is repeatedly flushed and written back, significant latencies may accumulate as a result of successive reconfigurations. By predicting which subsets of logic blocks are more likely to be used again, reconfiguration of those subsets may be avoided, decreasing latency.

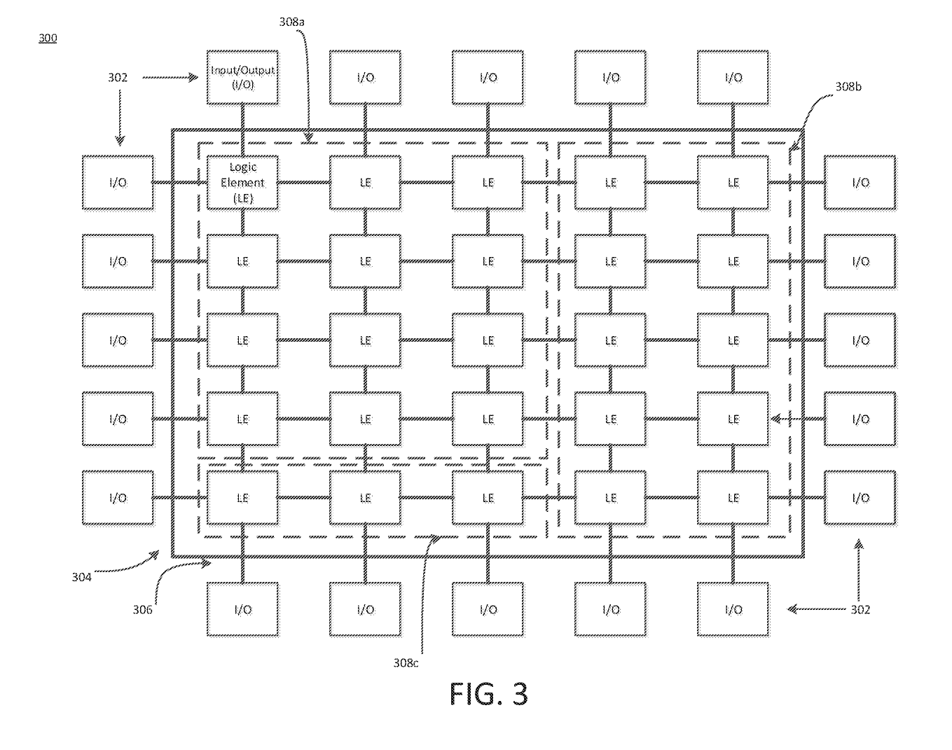

FIG. 3 illustrates a simplified portion of a reconfigurable IC 300. The IC 300 includes I/O pins 302, Logic Elements (LEs) 304, and interconnects 306. The LEs 304 are conceptually divided into a first subset 308a, a second subset 308b, and a third subset 308c. The interconnects 306 represent available communication interconnects, although in some embodiments, only a subset of the interconnects 306 will be physical, active connections.

Using the first subset 308a as an example, the first subset 308a may be considered a fetched logic partition, because the LEs making up the first subset 308a are partitioned off from the second subset 308b, the third subset 308c, and any other logic subsets not shown to execute a computation. When the first subset 308a receives an input (for example, from one or more of the I/O pins 302), the first subset 308a is immediately able to execute a computation, and produces an output that may be provided to one or more of the I/O pins 302.

The first subset 308a may therefore be considered to act as a primary cache in operation. If the FPGA needs to process an input data stream according to a specific computation, and the first subset 308a is partitioned and configured to perform the computation, then the input data stream may be immediately processed by the first subset 308a. Conceptually, this is similar to the easy accessibility of cached data.

However, since all of the LEs 304 shown are partitioned off into subsets, the IC 300 does not have any available LEs 304 if a computation is required that none of the first subset 308a, second subset 308b, and third subset 308c are capable of executing. For example, the IC 300 may include a controller, or be coupled to a controller, that is capable of reconfiguring the LEs 304, and needs the LEs 304 to execute a computation. Accordingly, the controller may need to wait for a subset of the LEs 304 to become available and reconfigure the subset of the LEs 304 to perform the computation. The reconfiguration time necessarily takes an amount of time that represents a latency in computing.

In one example, suppose that the first subset 308a is configured in a partition that frequently processes input data. Conversely, the second subset 308b and the third subset 308c are configured in partitions that do not frequently process input data. If the IC 300 needs to fetch a new partition other than the first subset 308a, the second subset 308b, or the third subset 308c to perform a new computation, it may be inefficient to reconfigure the first subset 308a in the new partition.

More specifically, it may be inefficient because the first subset 308a is configured in a partition that is frequently needed. To avoid or minimize the latencies associated with reconfiguration, the reconfigured partitions should ideally be those partitions that are least likely to be necessary for future computations, to avoid future write-backs of frequently used partitions. Accordingly, it would be advantageous to be able to execute a run-time prediction of next-needed logic element partitions in order to retain, or “pre-fetch,” logic element partitions.

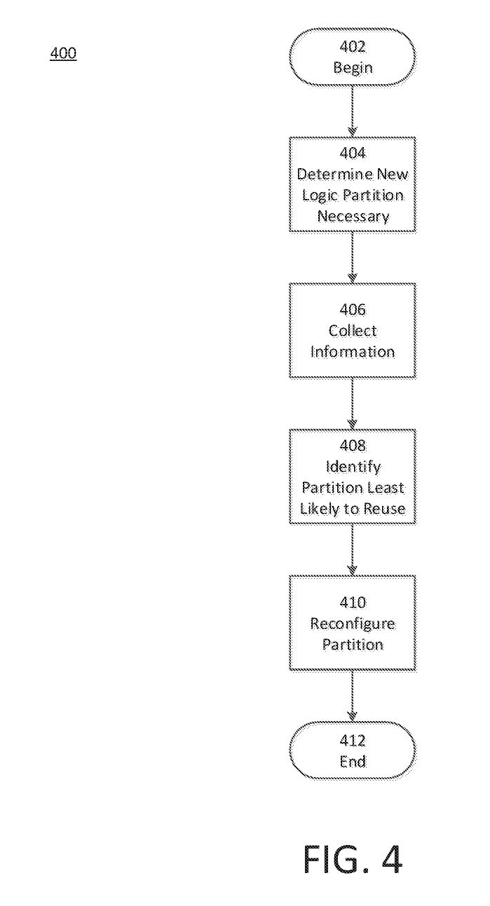

FIG. 4 illustrates a process 400 for anticipating dynamic reuse of fetched logic partitions in a reconfigurable logic device having a plurality of logic block partitions, such as the one shown in FIG. 3. The process 400 may be executed, for example, by a controller internal or external to the reconfigurable logic device.

At act 402, the process 400 begins. At act 404, a determination is made that a new logic partition is necessary. For example, the reconfigurable logic device may determine that none of the configured logic partitions are capable of performing a computation that must be executed.

At act 406, information indicative of a likelihood of reuse is collected. For example, each logic block partition may be polled for timestamp information indicative of an amount of time that has elapsed since the respective logic block last executed a computation. Alternatively, timing information may be derived from an energy consumption of one or more analog transistors within the logic block. A transistor-level analog measure of charge is detected, where the charge decays at a rate corresponding to a time constant. Accordingly, timing information may be derived from the energy measurement by extrapolating the energy to a decay time.

At act 408, a logic block partition which is least likely to be reused is identified based on the information collected at act 406. For example, if timestamp information was collected at act 406, then a Least-Recently Used (LRU) logic block partition may be identified and determined to be the least likely logic block partition to be reused.

Generally speaking, a logic block partition that has not been used for a long period of time is less likely to be reused than, for example, a logic block partition that has been most recently used, because a logic block partition that has frequently been used is unlikely to spend a significant amount of time without being used again. At act 410, the logic block partition that is least likely to be reused is reconfigured. At act 412, the process 400 ends.

Compile-time prediction of subsequently needed logic block partitions to retain logic block partitions may yield significant reductions in processing latency. Because logic block partitions that are frequently used are not often reconfigured, significant reductions in reconfiguration time may be achieved. In some examples, performance can be increased by up to three-fold as compared to a reconfigurable system that does not intelligently reconfigure logic block partitions.

Alternate approaches may be employed to estimate a likelihood of reuse. For example, in some embodiments, the estimation of a likelihood of reuse may be based on data type. Certain data types tend to evolve in specific branches which, if known ahead of time, may be used to predict which logic block partitions are most likely to be reused.

Other examples of partition replacement policies, or caching algorithms, which may be used to govern partition replacement include replacing a most recently used partition (Most Recently Used [MRU] replacement), replacing a most recently generated partition (First In First Out [FIFO] replacement), replacing a least recently generated partition (Last In First Out [LIFO] replacement), replacing partitions randomly (Random Replacement [RR]), replacing a least frequently used partition (Least Frequently Used [LFU] replacement), any combination of the foregoing, and/or any known cache or partition replacement policies.

In some embodiments, spatial or temporal localities may be utilized to predict which logic block partitions are likely to be needed in the future. In other embodiments, if a control graph of a computation is known, a likelihood of future reuse may be determined from the control graph. In yet other embodiments, a combination of some or all of the foregoing techniques may be used to accurately predict a likelihood of future reuse.

Although some of the foregoing examples describe the reconfiguration of an FPGA, the principles discussed above may be applied to alternate reconfigurable hardware. In some embodiments, the principles discussed above may be combined with additional improvements to reconfigurable hardware to provide synergistic increases in efficiency. For example, the principles discussed above may be implemented in combination with one or more additional principles, such as cross-bar fabric of SOP clusters, stochastic data-driven dynamic logic reallocation, and MTNCL architecture.

Although the foregoing discussion has been directed to selectively retaining logic block partitions for reuse, additional increases in efficiency may be achieved by executing pre-fetch operations. More specifically, logic block partitions that are likely to be needed in the future can be pre-fetched, or pre-configured, in anticipation of being needed in the future. Accordingly, when the logic block partition is needed, the blocks have already been partitioned and can immediately begin executing a computation without any configuration latency.

Accordingly, examples provided above may materially increase the computing power and efficiency of reconfigurable logic devices. For example, stochastic data-driven dynamic logic reallocation, as discussed above at least with respect to FIGS. 1 and 2, enable logic blocks to be reassigned where an input to the respective logic blocks has not changed recently. If logic elements, or partitions of logic elements, need to be reconfigured to execute different logical functions, predictive cache-based pipelined dynamic partial reconfiguration, as discussed above at least with respect to FIGS. 3 and 4, may be implemented to ensure that logic partition reconfiguration is executed to minimize a number of undesirable write-backs. Therefore, it is to be appreciated that both the dynamic logic reallocation techniques and dynamic partial reconfiguration techniques disclosed above may be executed in the same environment to synergistically increase the computing power and efficiency of reconfigurable logic devices.

In light of the foregoing, it is to be appreciated that methods and systems have been provided to identify portions of data streams received by reconfigurable ICs which are likely to remain fixed. Responsive to identifying the portions of the data streams, logic blocks configured to process the portions of the data streams may be reconfigured to process different data streams, thereby increasing the processing power of a reconfigurable IC having a finite number of logic blocks. Additionally, methods and systems have been provided to identify, at run-time, logic block partitions that are likely to be reused, and which are unlikely to be reused. Logic block partitions that are unlikely to be reused may be reconfigured, whereas logic block partitions that are likely to be reused may be retained or pre-fetched. Implementation of the foregoing enables significant improvements in performance by reducing logic block partition reconfiguration latency.

Although some of the foregoing examples describe the reconfiguration of specific forms of reconfigurable hardware, similar principles may be applied to any form of reconfigurable hardware. Furthermore, the foregoing principles may be combined with other optimizations to reconfigurable hardware to yield a synergistic effect in processing efficiency improvements.

As discussed above, partitions of logic blocks may be implemented to execute a logical function or functions. Accordingly, it must be determined which logical blocks are to be implemented to achieve a desired logical function. In some conventional systems, logical blocks may be ineffectively selected such that more logical blocks are utilized than are necessary to implement a logical function, which decreases efficiency in a reconfigurable hardware architecture having limited resources. Accordingly, further improvements to reconfigurable hardware architectures may be achieved by determining a minimal number of logical elements which may be implemented to execute a logical function.

Processors are generally configured to execute instructions expressed by low-level programming language. Low-level programming languages may be difficult for human operators (for example, programmers) to understand, because the languages have not been abstracted to a form customized for human understanding. For example, low-level programming languages may include a set of instructions represented by a stream of binary information, which may not be easily understood by a human operator.

Human operators generally utilize high-level programming languages, which represent instructions at a higher abstraction. The human operator may generate instructions in a human-readable format using the high-level programming language; a compiler then translates the instructions to a low-level, computer-readable language to be executed by a processor. In a broader sense, however, a compiler may describe computer software that translates computer code from one language to another, and is not limited to translation of a high-level language to a low-level language.

Developing compilers for high-level languages is difficult, and compilers are subject to constant improvement as bugs are worked out. Accordingly, maturation of a high-level compiler requires long development times, and wide and/or extensive use, to identify and address bugs. Similar principles apply, for example, to synthesis tools used to generate high-level designs in a Hardware Description Language (HDL), which are subsequently compiled to a description of an interconnectivity scheme of logic gates (a “netlist”). For example, a netlist may include a list of the electronic components in a circuit and a list of the nodes to which they are connected.

Some efforts have been made to cross-compile a high-level programming language, such as C, to a logic gate netlist, to allow for the design and creation of an electronic circuit that executes the high-level instructions at the hardware level. The ability to cross-compile between a high-level programming language to a logic gate netlist may provide significant advantages by allowing a resultant set of logic gate interconnections to be correct from a time of construction. Otherwise, in the translation of a high-level programming language to a logic gate netlist, imperfections may be introduced to the netlist.

For example, the crudely translated netlist may include worst-case data-width support for every operation, which may unnecessarily utilize an excessive amount of hardware. However, while cross-compilers capable of identifying and eliminating these imperfections would be advantageous, current cross-compilers suffer from various drawbacks and technical restraints inherent to immature compilers.

Accordingly, methods and systems are provided that address the foregoing deficiencies. Examples are provided in which instructions expressed in C are translated to SOP configurations to enable correct-by-construction logic. Machine instructions are analyzed to identify tautologies and contradictions, which may be trimmed away from compiled algorithms. A tautology is a logical formula which is always true regardless of the input. Conversely, a contradiction occurs when two logically incompatible outputs simultaneously occur. Tautologies and contradictions may be considered undesirable in computing, because they may lead to wasteful expenditure of computing resources. For example, in the case of a tautology, it may be wasteful to expend computing resources to perform a calculation which is known to be true ahead of time.

As discussed above, machine code may be executed directly by a computer processor. The machine code includes a sequence of instructions that may include one of a memory/register access instruction, a logical operation instruction, and a jump operation to another “location” in the sequence of instructions, all operating on a defined data word width.

Examples are provided in which computer instructions are mapped to a control flow graph. A control flow graph is a graphical representation of every possible path that a program might traverse during execution of the program instructions. In operation, the control flow graph may provide insight into portions of the instructions which are unnecessary and which bits may be trimmed away. By identifying bits which may be trimmed away, logic can be constructed which does not needlessly account for unnecessary bits.

Furthermore, the control flow graph may be used to identify tautologies and contradictions. If tautologies and contradictions can be identified from the control flow graph, they can be trimmed away from compiled algorithms such that the compiled algorithms only include necessary, logically consistent functions.

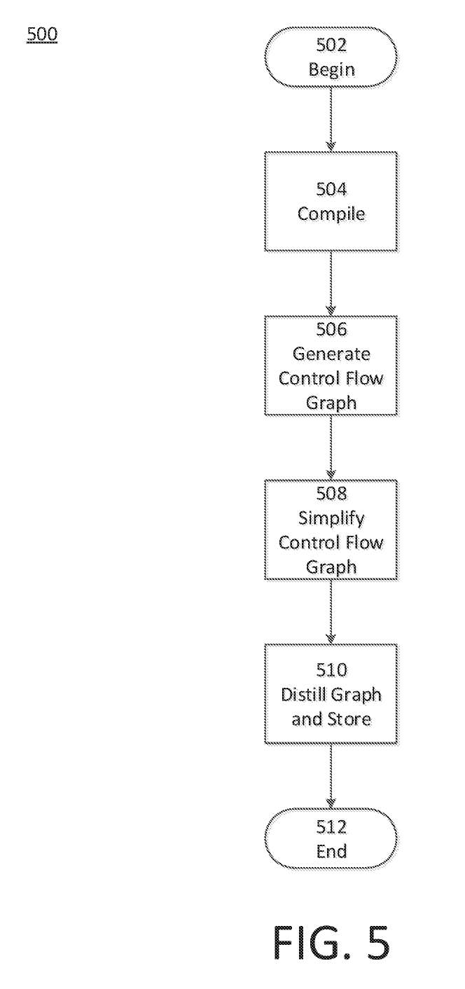

FIG. 5 illustrates a process 500 for minimizing a processor instruction stream according to an embodiment. The process 500 may be executed, for example, by one or more processors of a computer capable of supporting a human-readable programming language, such as C. At act 502, the process 500 begins. At act 504, a compiler translates a block of code from a high-level programming language to a machine-executable programming language. For example, the compiler may translate a block of code from C to machine code. After compiling, the process 500 continues on to act 506.

At act 506, a control flow graph is generated. For example, the control flow graph may be generated by mapping the machine code compiled at act 504, which includes an instruction sequence, to bitwise Boolean logic operations, where the control flow graph preserves the data dependency.

At act 508, the control flow graph is simplified. For example, sequences of the bitwise Boolean logic operations may be collapsed to minimal canonical form of either SOP or Product-of-Sums (POS). Minimizing the Boolean logic operations to canonical form may be executed using any conventional methods.

The ability to represent the operations in minimal canonical form allows extraneous or redundant operations to be trimmed away such that, when the operations are implemented as physical logic, the logic is already correct by construction and does not include unnecessary elements.

At act 510, the simplified control flow graph is distilled to one or more interconnected cones of logic organized and stored in a memory that is internal or external to the computer executing the process 500. If the logical cone represents a terminal node of the control flow graph (i.e., a node which does not lead to a subsequent node in the control flow graph), then the logical cone is connected to an output. Otherwise, if the logical cone represents a node that feeds back to the control graph, then the logical cone is terminated with a sequential logic element to preserve a timing order. For example, the sequential logic element may include a flip-flop. At act 512, the process 500 ends.

The output of the process 500, which may be generally referred to as a netlist, may be subsequently provided to a second computer having a memory, one or more processors, and reconfigurable hardware. For example, because the output of the process 500 has been trimmed down to a minimal canonical form, the output of the process 500 may be directly mapped to a configuration of logic gates in the reconfigurable hardware, which is correct by construction. An FPGA, for example, could configure one or more logic blocks to implement the output of the process 500. In some embodiments, the memory discussed above with respect to act 510 may be a memory internal to reconfigurable hardware, such as an FPGA.

An FPGA implementing the output of the process 500 is only required to dedicate a bare minimum of hardware necessary to implement the block of code received at act 504 of the process 500. If the block of code had not been trimmed according to the foregoing principles, then the FPGA may have dedicated extra hardware resources to extraneous operations. For example, the FPGA may have needlessly dedicated one or more logic blocks to a tautological or contradictory operation.

By minimizing the amount of hardware that an FPGA must dedicate to executing a block of code, the processing power of the FPGA may be improved without changing the amount of processing hardware in the FPGA. It is to be appreciated that FPGAs have been specifically identified for purposes of example only. The process 500 may be executed in connection with any reconfigurable hardware. Moreover, the process 500 may be executed in combination with the embodiments discussed above in connection with FIGS. 1-4.

The foregoing principles may be executed by a computer operating as a cross-assembler. A cross-assembler is an assembler which is run on a first computer of a different type than the computer that is to run code generated by the first computer. For example, the first computer may be a user computer on which the user writes a program in C, and the second computer may be a computer including reconfigurable hardware which executes the code that was originally written in C.

Accordingly, it is to be appreciated that the foregoing principles may increase the processing power of reconfigurable hardware by enabling code written in a high-level, human-readable language to be mapped very closely to an interconnection of logic gates in reconfigurable hardware. However, this close mapping may be accomplished without requiring the human user to consciously map functions to logic gates while writing in the high-level language. Unnecessary and redundant operations in a sequence of instructions are identified at the assembler or machine instruction level, namely by considering the fundamental jump, fetch, and operate instructions. These fundamental instructions are optimized and mapped to logic gates such that the logical implementation is correct by construction.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention.

Accordingly, the foregoing description and drawings are by way of example only.

What is claimed is:

1. A method for reallocating logic blocks in reconfigurable hardware, the method comprising:
receiving a first bit array having a plurality of bits, the plurality of bits including a first subset of bits and a second subset of bits;
providing the first subset of bits to a first logic block of a plurality of logic blocks, and the second subset of bits to a second logic block of the plurality of logic blocks;
determining that the first logic block has not performed a calculation for a specified amount of time; and
reconfiguring the first logic block to process at least a portion of a second bit array.

2. The method of claim 1, further comprising:
processing, by the first logic blocks, the first subset of bits to produce an output; and
holding the output for reuse.

3. The method of claim 1, further comprising providing a first timestamp to the first logic blocks simultaneously with the first subset of bits.

4. The method of claim 3, further comprising:
determining, by the first logic block, that the first subset of bits is different than a most-recently received subset of bits; and
storing, by the first logic block, the first timestamp.

5. The method of claim 3, further comprising:
determining, by the first logic block, that the first subset of bits is the same as a most-recently received subset of bits; and
disregarding, by the first logic block, the first timestamp.

6. The method of claim 3, further comprising:
polling the plurality of logic blocks for a stored timestamp; and
receiving a plurality of timestamps from the plurality of logic blocks, the plurality of timestamps including the first timestamp.

7. The method of claim 6, further comprising determining whether any timestamp of the plurality of timestamps has exceeded a threshold amount of time.

8. The method of claim 1, further comprising determining that the first logic block satisfies a condition.

9. The method of claim 1, wherein determining that the first logic block has not performed the calculation for the specified amount of time includes measuring an energy consumption by a transistor in the first logic block.

10. The method of claim 1, wherein determining that the first logic block has not performed the calculation for the specified amount of time includes determining that a minimum number of clock cycles have elapsed.

11. The method of claim 10, wherein determining that the first logic block has not performed the calculation for the specified amount of time includes determining that a minimum number of fractions of a second have elapsed.

12. A reconfigurable Integrated Circuit (IC) comprising:
one or more input pins configured to receive a first bit array having a plurality of bits, the plurality of bits including a first subset of bits and a second subset of bits;
a plurality of logic blocks including a first logic block, a second logic block, and a third logic block, the first logic block and the second logic block being interconnected; and
a controller coupled to the one or more input pins and the plurality of logic blocks, the controller configured to:
provide the first subset of bits to the first logic block of the plurality of logic blocks, and the second subset of bits to the second logic block of the plurality of logic blocks;
determine that the first logic block has not performed a calculation for a specified amount of time;
disconnect the first logic block from the second logic block; and
connect the first logic block to the third logic block.

13. The IC of claim 12, further comprising a memory, wherein the first logic block is configured to process the first subset of bits to produce an output, and wherein the controller is further configured to store the output in the memory.

14. The method of claim 12, wherein determining that the first logic block has not performed the calculation for the specified amount of time includes measuring an energy consumption by a transistor in the first logic block.

15. The IC of claim 12, wherein the controller is further configured to provide a first timestamp to the first logic block simultaneously with the first subset of bits.

16. The IC of claim 15, wherein the first logic block includes a memory and is configured to:
determine that the first subset of bits is different than a most-recently received subset of bits; and
store the first timestamp.

17. The IC of claim 15, wherein the first logic block is further configured to:
determine that the first subset of bits is the same as a most-recently received subset of bits; and
disregard the first timestamp.

18. The IC of claim 15, wherein the controller is further configured to:
poll the plurality of logic blocks for a stored timestamp; and
receive a plurality of timestamps from the plurality of logic blocks, the plurality of timestamps including the first timestamp.

19. The IC of claim 18, wherein the controller is further configured to determine, based on the plurality of timestamps, that the first timestamp has exceeded a threshold amount of time.

20. The IC of claim 19, wherein determining that the first logic block has not performed the calculation for the specified amount of time includes determining that a minimum number of clock cycles have elapsed.

21. The IC of claim 19, wherein determining that the first logic block has not performed the calculation for the specified amount of time includes determining that a minimum number of fractions of a second have elapsed.

22. A method of partitioning logic blocks in reconfigurable hardware including a plurality of logic block partitions, the method comprising:
collecting information indicative of a previous calculation from each logic block partition of the plurality of logic block partitions;
identifying, based on the information, a first logic block partition configured to execute a first calculation that is least likely to be reused; and
reconfiguring the first logic block partition to execute a second calculation based on the identification.

23. The method of claim 22, wherein the information includes timestamp information.

24. The method of claim 23, wherein the timestamp information includes a plurality of timestamps corresponding to a respective logic block partition of the plurality of logic block partitions and indicative of a time at which a corresponding logic block partition last executed a calculation.

25. The method of claim 24, wherein the plurality of timestamps includes a first timestamp corresponding to the first logic block partition, and wherein the first timestamp is an earliest timestamp of the plurality of timestamps.

26. The method of claim 22, further comprising predicting a likelihood of a second logic block partition being required, wherein the plurality of logic block partitions does not include the second logic block partition.

27. The method of claim 26, further comprising pre-fetching, based on the prediction, the second logic block partition.

28. The method of claim 27, wherein pre-fetching the second logic block partition includes reconfiguring the first logic block partition to the second logic block partition.

29. A reconfigurable Integrated Circuit (IC) comprising:
a plurality of logic block partitions including a first logic block partition and a second logic block partition; and
a controller coupled to the plurality of logic block partitions, the controller configured to:
collect information from the first logic block partition and the second logic block partition;
determine, based on the information, that the first logic block partition is less likely to be reused than the second logic block partition; and
reconfigure the first logic block partition to a third logic block partition.

30. The IC of claim 29, wherein the information includes timestamp information.

31. The IC of claim 30, wherein the timestamp information includes a plurality of timestamps corresponding to a respective logic block partition of the plurality of logic block partitions and indicative of a time at which a corresponding logic block partition last executed a calculation.

32. The IC of claim 31, wherein the plurality of timestamps includes a first timestamp corresponding to the first logic block partition, and wherein the first timestamp is an earliest timestamp of the plurality of timestamps.

33. The IC of claim 29, wherein the controller is further configured to predict a likelihood of a third logic block partition being required.

34. The IC of claim 33, wherein the plurality of logic block partitions does not include the third logic block partition.

35. The IC of claim 34, wherein the controller is further configured to pre-fetch, based on the prediction, the third logic block partition.

36. The IC of claim 35, wherein the controller pre-fetching the third logic block partition includes the controller reconfiguring the first logic block partition to the third logic block partition.
